(19) United States
(12) Patent Application Publication
(10) Pub. No.: US 2012/0052186 A1
(43) Pub. Date: Mar. 1, 2012

(54) METHOD FOR THE PRODUCTION OF DENTURES

(75) Inventors: JOACHIM JUNGLAS, Mayen (DE); MICHAEL BROGHAMMER, KELTERN (DE); FALKO NOACK, LUSTENAU (AT)

(73) Assignee: AMANN GIRRBACH AG, KOBLACH (AT)

(21) Appl. No.: 13/216,340

(22) Filed: Aug. 24, 2011

(30) Foreign Application Priority Data
Aug. 25, 2010 (DE) 102010 037 160.2

(51) Int. Cl. A61C 13/09; B05C 11/00

(52) U.S. Cl. 427/2.29; 118/696

(57) ABSTRACT

A method for the production of dentures, in which for the production of a veneer (1) several layers (4) of at least one material mixture are applied on a support frame (2), on a spatially curved exterior surface (3) of the support frame (2), particularly in a computer-controlled fashion based on a digital model of the denture, with the layers (4) of the material mixture being applied as layers arranged spatially curved, with several layers (4) of the material mixture being applied directly following each other.

### CROSS-REFERENCE TO RELATED APPLICATIONS

This application claims the benefit of German Patent Application No. DE 10 2010 037 160.2, filed Aug. 25, 2010, which is incorporated herein by reference as if fully set forth.

### BACKGROUND

The present invention relates to a method for the production of dentures, in which for the production of veneers on a support frame, several layers of at least one material mixture are applied to a spatially curved exterior surface of a support frame, in an automated, particularly a computer-controlled fashion according to a digital model of the dentures, with the layers of the material mixture being applied as layers arranged in a spatially curved manner.

Furthermore, the invention also relates to a layering device for implementing the method.

For the production of dentures it is not only important to optimally embody the tooth or parts of the tooth with regards to strength and shape but also to adjust the exterior appearance of the denture and/or its coloring to the still existing teeth in the mouth of the patient, to the extent possible. For this purpose it is known in prior art to manually model the veneer of the denture on a support frame. This is very laborious and expensive. In prior art several automated production methods are known. For example, U.S. Pat. No. 4,937,928 discloses a generic method for the production of dentures. Here, using a CAD/CAM-system the denture is constructed layer for layer by individual ceramic layers being applied on a metallic support frame and each layer is sintered after its application and mechanically post-processed before the next layer is applied. This automated method as shown in prior art is still very expensive, because sintering as well as post-processing occurs after the application of each layer.

In addition to the above-mentioned generic methods, non-generic methods are known in prior art. They are based on first mathematically dissecting the dentures to be produced into horizontal sections and to successively construct these horizontal sections by an appropriate horizontal layering. In these generic methods the layers of the material mixture are therefore applied in horizontal layers and not as layers arranged spatially curved. Such a method is disclosed, e.g., in U.S. Pat. No. 7,686,989 B2.

### SUMMARY

The objective according to the invention is therefore to provide an alternative generic method, which allows the production of dentures in a more efficient and thus more cost-effective manner.

For this purpose it is provided according to the invention that several layers of the material mixture are applied immediately after each other.

In other words, it is therefore provided that several or at least two layers of the material mixture are applied immediately after each other without any other processing steps being performed therebetween. In particular, after each individual layer no intermediate sintering or mechanical processing is provided. This leads to a considerably more effective and faster production of the dentures. Here, it is not mandatory for all layers to be constructed without any intermediate processing. It is sufficient that between other, potentially necessary processing steps, two or more layers of the material mixture are applied directly following each other. Here, the first layer is directly applied on the support frame and/or its exterior surface as a layer arranged spatially curved. In the subsequent layers, arranged spatially curved, a direct application occurs onto the support frame, because these layers are applied onto layers already existing on the support frame. The applied layers are then positioned directly following each other, also with regards to their spatial positioning.

For reasons of completeness it is pointed out that the term dentures shall be understood as both the replacement of a part of a tooth and the replacement of an entire tooth as well as the replacement of several teeth, e.g., in the form of a bridge and/or several parts of teeth. Within the scope of the invention it is preferably provided that the support frame is a component of the finished denture and thus implanted and/or integrated therewith in the mouth of the patient.

Preferred embodiments of the invention provide that the curing of the already applied layers of the material mixture occurs only after the application of several layers of the material mixture in a separate processing step, preferably after the application of all layers of the veneer. Sintering or light-curing may be performed in a separate processing step, for example. Particularly preferred it is provided that a mixture comprising at least one liquid component, preferably in the form of a binder and at least one powdered component, preferably in the form of a ceramic powder or a plastic powder is applied as the material mixture. Here, one variant comprises that a suspension is applied as the material mixture, preferably premixed or only mixed directly prior to or during application. In other variants of the method according to the invention it may also be provided, though, that the layers of the material mixture are each applied in at least two separate processing steps, in which preferably first a liquid component is applied, preferably in the form of a binder, and preferably subsequently in another processing step at least one powdered component, preferably in the form of a ceramic powder or a plastic powder.

The method according to the invention may be implemented using most different material mixtures. A first group of variants provides here to use ceramic materials. Here, both of the above-mentioned variants are possible. The ceramic materials can here therefore be already applied as a suspension in order to form the layers. However, it is just as well possible to apply preferably first at least one liquid component, preferably in the form of a binder, and preferably subsequently the ceramic material in the form of a ceramic powder. Here, various binders may be used as the liquid component. Particularly preferred it is provided here that the binder comprises an adhesive component, preferably based on protein. The binders may have a composition, for example, having an adhesive portion, such as protein, gelatin, glue, and the like, ranging from 2 to 80 percent by volume. Further, the liquid components and/or the binder may include a volatile component, preferably alcohol, at a portion of 5 to 50% by volume. This may support rapid drying. Further, in order to fulfill a diluting function it is possible for the liquid component and/or the binder to comprise distilled water from 20 to 40 percent by volume. Furthermore, wetting adjuvants and thickening agents, such as cellulose, may be present in the liquid component. The adhesive effect of this liquid component is of primary importance. However, it is also beneficial for a liquid component to be selected, which burns without any residue during the ceramic burn and/or sintering. Beneficially, the liquid component should be fast drying and self-drying in order to ensure a timely application of several subsequent layers one after the other. The ceramic powder is selected with a suitable particle size, distribution of the particle sizes, and particle shapes. Here, materials and/or glass is selected which even in very thin layers provides the desired color effect and/or translucency. This may be further improved in combinations with particular support frames, such as anatomically colored, reduced support frames. Ceramic materials with a good wetting ability are advantageous.

As an alternative for the use of ceramic materials, plastics may also be used as the material mixture for the method according to the invention. Here, too, both the application of previously mixed suspensions as well as the successive application of liquid components and powdered components is possible. Various polymers may be used. Their curing may occur chemically but also in separate processing steps, e.g., by way of light curing. Both the material mixtures composed on a ceramic basis as well as a plastic basis may be differently dyed in order to produce various shades of color. Here, the liquid or the powdered components or the entire suspension may be dyed. Additionally, color effects may also be created via appropriately dyed surfaces of the support frame. The same applies for the translucent features of the materials used.

Generally, a natural tooth to be replaced is differently colored in different sections, therefore it should also be possible to realize that effect in the denture to be produced. In order to allow implementation of that effect in the artificially produced denture it is advantageous if at least one first material mixture is applied in a first partial area or in first partial areas of the veneer to be produced and at least one other preferably differently dyed material mixture or several other, preferably differently dyed material mixtures is and/or are applied in other partial areas of the veneer to be produced. In the context of this application, veneer is intended to refer to the built up layers used to form part of the denture, regardless of whether it is for application to a front face of a tooth, the back face, the side face, or combinations of some or all faces of one or more teeth, and is not limited to cosmetic “dental veneers” that are applied only to the front face of a tooth.

In preparation of the above-mentioned steps of the method according to the invention and its preferred embodiments, the patient's situation is beneficially available as a virtual model. Here, both the color as well as the geometric information may be obtained by an intraoral or extraoral scanning of actually existing teeth, models, or molds, i.e. negative models. The color information may also be obtained by different means, of course, e.g., by comparison with still existing neighboring teeth. Then it is beneficially provided to construct the denture as an anatomic form, e.g., by using CAD software. Subsequently, by way of calculation the entire denture to be produced can be dissected on a digital level into a support frame and a veneer. With regards to the support frame, standard forms may be used or, as explained in greater detail in the following and known per se in prior art, it may be produced in advance. The support frame advantageously forms a minimized anatomic tooth shape, which can be created, e.g., from a standard tooth shape saved in suitable software. As a next step, it may be provided to divide the veneer by way of calculation into different color zones and/or differently dyed partial areas. This may e.g., occur based on diagrams of color schemes saved in a library. The classification of the different color zones and/or differently dyed partial areas may also occur based on previous color analyses of still existing teeth of the patient. When producing the denture by applying layers onto the spatially curved support frame, the color zones and/or partial areas may be selected freely. For example, it is beneficially provided initially to produce the first partial area by constructing several layers in order to subsequently produce differently dyed partial areas using the appropriate layered construction. Here, the production of one partial area after another may occur until the veneer is produced in its final form. The shrinkage or expansion factor to be expected depending on the material mixture used is advantageously considered for the calculation of the geometry of the denture to be produced. For example, when ceramic materials are used, e.g., the shrinkage during sintering may be considered. Further, it is beneficial at the monitor to provide a real color demonstration of the tooth to be veneered for controlling purposes. Further, when producing dentures based on a digital model, e.g., constructed by way of CAD, advantageously coordinates and/or zero-point systems may be applied, which allow an appropriate transfer of the geometric information from the digital model to the denture actually to be produced. This always ensures the positioning and repositioning of the support frame in the coordinate system of the respective processing step. The data sets for producing the veneers are advantageously constructed via CAD.

It is also possible to construct the support frame via CAD. The production of the support frame can also occur according to any variants known in prior art. In any case, a portion of the denture is considered the support frame, upon which the layers of the veneer are applied in order to complete the denture. When inserting the denture into the set of the patient's teeth, the support frame then represents the part which directly contacts the tooth stump of the patient. The support frame is therefore the part of the denture, via which the fastening occurs in the mouth of the patient.

The materials for producing the support frame may vary. Here, examples are ceramic materials, such as zirconium dioxide, lithium disilicate, glass ceramics, sintered ceramics, etc. However, they may also represent metallic support frames made from non-precious metals or precious metals, titanium, or metal alloys. Further, support frames may also be used comprising plastics, for example polymers. The support frames may be produced, as generally known, via casting, laser sintering, cutting, polishing, printing, stereo-lithography, etc.

A support frame receiver may also be produced, which serves to fasten to the layering device to be discussed in the following. On the one hand, the support frame receiver may be fastened and/or formed directly at the support frame. In this case, it is also created during the production process of the support frame. The geometry of the support frame receiver may be saved, e.g., in a suitable software. Alternatively, the support frame receiver may be produced as a model, which can be fastened in a form-fitting manner at the support frame e.g., in an interior hollow space of said support frame. The surface of the support frame, upon which the layers of the veneer are applied, can be pretreated and/or conditioned by way of blasting, cleaning, dissolving etc. The support frame may comprise an interior hollow space, which serves for fastening on to the tooth stump. This hollow space and/or the contact surface provided for fastening at the tooth stump is advantageously covered when applying the layers of the veneer. As already mentioned, the surface of the support frame may contribute to the coloring of the denture by applying appropriate dyes, opaquers, and/or liners. Here, the above-mentioned colors, intensive dyes, opaquers, and liners may be applied over the entire exterior surface of the support frame or only in individual partial sections. The application can occur in a spraying method, punctually, or over an extended area, for example via air-brush coating. Alternatively, the application can occur via nozzles or paint brushes. When the support frame is produced from a ceramic material a first sintering burn of the support frame may occur before the layers of the veneer are applied.

In order to implement the method according to the invention a layering device may be used which is characterized in the layering device comprising at least one support frame receiver, at which the support frame can be fastened, and at least one positioning device for positioning the support frame receiver in the space and at least one applying device, preferably several separate applying devices to apply the material mixture and at least one computer-supported control device, with the positioning device and/or the applying device(s) being addressed by the control device, preferably mobile in space. Advantageously this layering device includes a vibration device to vibrate the denture and/or the support frame receiver. In order to allow applying very quickly different, particularly differently dyed material mixtures onto the support frame, preferred embodiments of the layering device provide that they comprise a magazine for providing different, preferably differently dyed material mixtures and/or components of material mixtures. In order to allow drying different layers as quickly as possible the layering device may comprise at least one drying device for drying the material mixture. In order to allow performing minor corrections of the shape the layering device may further comprise at least one mechanic shaping device for post-processing the shape of the applied layers of the material mixture. Possible shaping devices are boring, cutting, or other shaping tools, such as blades.

### BRIEF DESCRIPTION OF THE DRAWINGS

Additional features and details of preferred embodiments of the invention are discernible from the following description of the figures. Shown are:

FIG. 1 is a schematic illustration of a longitudinal cross-section through a denture produced according to the invention and already fastened on a tooth stump;

FIG. 2 is a corresponding exploded illustration;

FIG. 3 is a schematic detailed illustration of the section 21 of FIG. 1, and

FIG. 4 is a schematic illustration of a layering device to perform the method according to the invention.

### DETAILED DESCRIPTION OF THE PREFERRED EMBODIMENTS

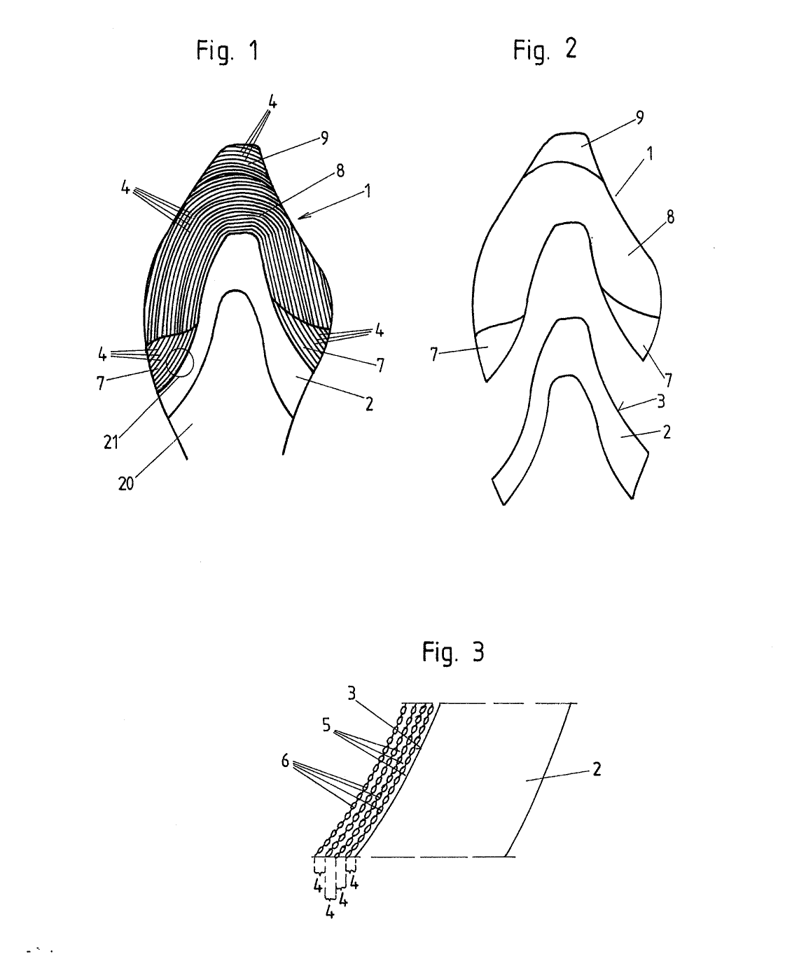

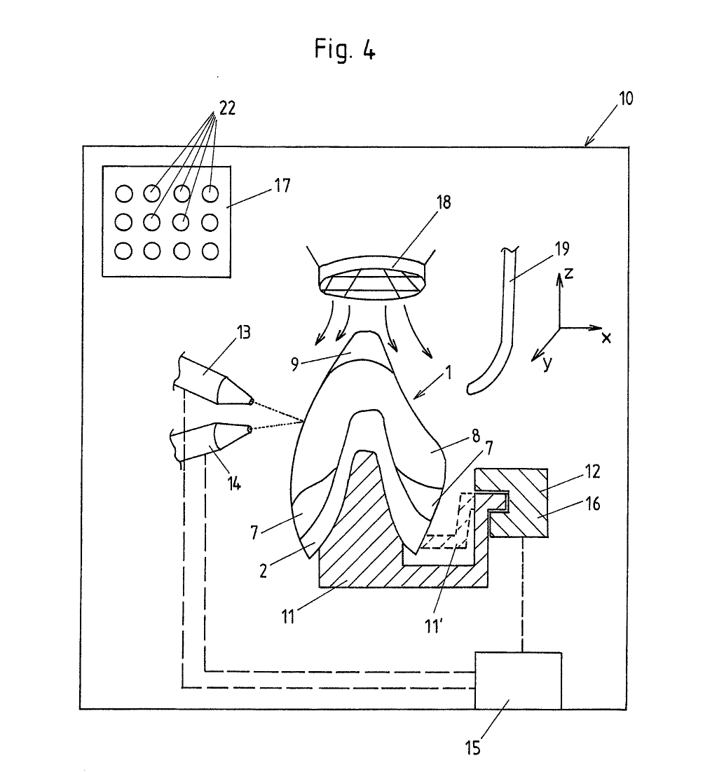

FIG. 1 shows schematically the veneer 1 in a longitudinal cross-section and produced according to the method of the invention, which is already fastened on the tooth stump 20 via a support frame 2. The veneer 1 applied on the support frame 2 via the method according to the invention comprises the differently dyed partial sections 7, 8, and 9, for example. Each of these partial sections was produced by applying several layers 4 of the material mixture, with according to the invention always several layers 4 of the material mixture are applied directly following another one. The layers 4 follow with their shape the respective form of the exterior surface 3 of the support frame 2 and/or the subjacent layers 4. Thus, the layers 4 of the material mixture represent layers arranged spatially curved. The thickness of the layers 4 may vary. In FIG. 2 the schematic illustration of the individual layers 4 is not shown. Further, the veneer 1 with its partial sections 7, 8, and 9 and the support frame 2 with its exterior surface 3 are shown in an exploded representation in order to demonstrate the separation between these two partial sections of the denture. FIG. 3 shows the section 21 of FIG. 1 and thus, in an enlarged fashion, the structure of the layers 4 on the exterior surface 3 of the support frame 2. In the variant shown in FIG. 3, the material mixture respectively forming a layer 4 was applied in two processing steps separated from each other. In an initial processing step, first a liquid component 5 was applied on the support frame 2 and/or the subjacent layer 4. Subsequently, in another following processing step, the powdered component 6 was applied onto said liquid component 5. A layer 4 is therefore always formed from the exterior resting powdered particles 6 and the subjacent liquid component 5, as schematically shown in FIG. 3. In order to apply the liquid components, spraying methods, dusting, misting, or also lacquering methods may be used. In any case, a fine, thin application is beneficial. The application may occur punctually, area-wise, or over the entire subjacent surface, depending on the size of the partial areas 7, 8, or 9 respectively to be produced. After application, the liquid component 5 forms a moist area on the support frame 2 and/or the subjacent layers 4, into which the powdered component 5 can be inserted and then adheres thereto. The powdered component is applied to the previously moistened zone and/or the respective partial section which is moistened with the liquid component. In order to apply the powdered components a spraying technique, disbursing technique, sprinkling, powdering, or even an injection technique may be used, to name just a few examples. Here, too, a fine, thin application is advantageous. Again, the application may occur punctually or over a partial section or over the entire subjacent structure. The application may occur in the form of particles or with a targeted powder jet. When applied onto the liquid component 5 the powdered component 6 saturates with the liquid of the liquid component 5. By the alternating application of the liquid component 5 and the powdered component 6, the layers 4 are formed. When the desired partial section 7, 8, or 9 has been produced this way in its desired colored embodiment, using an appropriately differently dyed material mixture, the construction of a different partial section 7, 8, or 9 can occur accordingly. The geometric information concerning the size and position of the respective partial sections 7, 8, or 9 are beneficially taken from the previously prepared digital model of the denture. Of course it is also possible, when so desired, to produce the entire veneer 1 from a single partial section, i.e. in a uniformly dyed embodiment. FIG. 3 particularly shows the variant of the method according to the invention, in which first the moistening with the liquid component 5 occurs and then the application of the powdered component 6. This is not the only possible variant according to the invention for producing the layers 4. Instead of this progression, the layers 4 may also be applied as previously mixed suspensions comprising the liquid component 5 and powdered components 6 as appropriately spatially curved layers 4. It is also possible, using suitable application devices 13 and 14, to mix the liquid component 5 with the powdered component 6 to a suspension immediately prior to impinging the base. The application of the layers advantageously occurs always from the thick (section) to the thin (section). The start of the application also advantageously occurs in the large-volume areas of the partial sections 7, 8, or 9 to be produced. The control of the application devices 13 and 14 used for applying the material, both with regards to the material used as well as the amount and the geometric information, is beneficially performed depending on the digital model prepared by the control device 15 shown in FIG. 4.

In order to ensure the homogeneity of the veneer 1 it is beneficial when the material mixture applied is set to vibrate, preferably by vibrating the support frame 2. This leads to compacting the already applied material mixture. This way, the vibration reduces shrinkage and avoids cracking during the curing process and particularly the sintering of the applied material mixture. The vibration is beneficially introduced, as already mentioned, via the support frame 2. The vibration device 16 is shown schematically in FIG. 4.

The layering device 10 shown schematically in FIG. 4 primarily serves for the automated application of layers 4 onto the support frame 2. The denture and/or the veneer 1 is almost completed in FIG. 4. In the exemplary embodiment shown, in order to fasten and position it, the support frame 2 is plugged onto a suitable support frame receiver 11. In the variant of the support frame receiver 11 shown in FIG. 4 in continuous lines, this receiver has previously been produced as a model which was fastened in an interior hollow space of the support frame 2 in a form-fitting manner and/or engages in a form-fitting manner into the hollow space of the support frame 2 in order to support the support frame 2. Additionally, FIG. 4 also shows in dot-dash lines an alternative variant of the support frame receiver 11′. In this variant the support frame receiver 11′ is fastened and/or formed directly at the support frame 2. In both variants, the respective support frame receiver 11 and/or 11′ is supported and positioned by the positioning device. The positioning device 12 beneficially allows an alignment and/or positioning of the support frame receiver 11 and thus the denture in the space depending on the controls of the control device 15, which in turn are based on the digital model of the denture to be produced. In the exemplary embodiment shown, the vibration device 16 is also integrated in the positioning device 12, via which the support frame receiver introduces the vibrations into the veneer 1. In order to apply the layers 4, in the exemplary embodiment shown, two application devices 13 and 14 are provided. They are appropriately controlled by the control device 15 depending on the underlying digital model of the denture to be produced. Here, the control device 15 controls both the motion as well as the amount of the respectively released material and the type of the material. It is possible, e.g., to use one of the application devices 13 to apply the liquid component 5 and the other application device 14 to apply the powdered component 6. The application devices may represent, e.g., nozzles, spraying devices, etc. It is also possible to apply previously mixed suspensions using the application device 13 and/or 14. Further, it is also possible to align the jets emitted by the two application devices towards each other such that the suspensions comprising liquid and powdered components mix immediately upon impinging the already produced parts of the denture or shortly therebefore. The mechanical embodiment of the application devices 13 and 14 may be embodied, e.g., similar to robot arms known per se. The control device 15 may be equipped with a CAM software to calculate the application lines and paths of multi-axial pivotal and displacing arms of the positioning device 12 and/or the application devices 13 and 14. In order to provide different powdered components 6, liquid components 5, and/or material mixtures already provided as suspensions in different colors a magazine 17 may be provided, in which appropriate cartridges or guns 22 with appropriately dyed materials are provided, with the application devices 13 and 14 may take, depending on the controls of the control device 15, the cartridges and/or syringes 22 from the magazine required for the partial section 7, 8, or 9 about to be produced. In order to accelerate the drying of the material mixture of the individual layers 4 the layering device 10 may comprise one or more drying devices 18. They may represent e.g., heat sources, suctioning papers, dabbers, or ventilating dryers or the like. For potentially necessary corrections of the shape of the veneer 1, the layering device 10 may comprise mechanical shaping devices 19, preferably also spatially mobile in various axes. They may be used for shaping, cutting, boring, etc. They may represent cutting or drilling devices or blades and the like. Here, corrections of the exterior shape of the individual partial sections 7, 8, or 9 or the entire veneer 1 may occur. The correction of the shape can occur in the layering device 10. The corrections of the shape are beneficially performed in the blank of the veneer 1 not yet cured and/or not yet sintered. The curing may occur, particularly when using plastic materials, by a chemical curing or by suitable light hardening even outside the layering device 10. When ceramic materials are used they are beneficially sintered after the production of the veneer and/or the veneer 1, using a sintering kiln known per se. The motions of the mobile parts of the layering device 10 via the control device 15 may be created, similar to CNC-controls known per se, for example similar to guiding a robot arm or the like to guide multi-axial processing heads of a cutting machine. Beneficially both the support frame receiver 11 and the application devices 13 and 14, as well as the mechanic shaping devices 19 and the light source for light curing, not shown here, and appropriately suitable drying devices 18 are here appropriately movable in various axes. The equipment of the application device 13 and/or 14 beneficially occurs also in an automated fashion via accessing the magazine 17 depending on appropriate controls of the control device 15.

### LEGEND FOR THE REFERENCE NUMBERS

1 Veneer
2 Support frame
3 Surface of the support frame
4 Layer
5 Liquid component
6 Powdered component
7 Partial section
8 Partial section
9 Partial section
10 Layering device
11, 11′ Support frame receiver
12 Positioning device
13 Application device
14 Application device
15 Control device
16 Vibration device
17 Magazine
18 Drying device
19 Mechanical shaping device
20 Tooth stump
21 Section
22 Cartridges or guns

1. A method for producing dentures, in which for production of a veneer (1) on a support frame (2) the method comprises applying several layers (4) of at least one material mixture automatically on the support frame (2), on an spatially curved, exterior surface (3) thereof, with the layers (4) of the material mixture being applied as spatially curved layers, wherein several of the layers (4) of the material mixture are applied directly following each other.

2. The method according to claim 1, further comprising curing the already applied layers (4) of the material mixture only after the application of several of the layers (4) of the material mixture, in a separate processing step.

3. The method according to claim 2, further comprising performing the curing by sintering or light curing in the separate processing step.

4. The method according to claim 2, further comprising curing the already applied layers (4) of the material mixture only after the application of all of the layers (4) of the veneer (1), in the separate processing step.

5. The method according to claim 1, wherein a mixture comprising at least one liquid component (5) and at least one powdered component (6) is applied as the material mixture.

6. The method according to claim 5, wherein the at least one liquid component includes a binder.

7. The method of claim 5, wherein the at least one powdered component includes a ceramic powder or a plastic powder.

8. The method according to claim 1, wherein a suspension is applied as the material mixture.

9. The method according to claim 8, wherein the suspension is previously mixed or only mixed immediately prior to or during the application.

10. The method according to claim 1, wherein the layers (4) of the material mixture are each applied in at least two separate processing steps, comprising, in one processing step applying at least one liquid component (5), and in another processing step applying at least one powdered component (6).

11. The method according to claim 10, wherein the at least one liquid component (5) is a binder.

12. The method according to claim 10, wherein the at least one powdered component is a ceramic powder or a plastic powder.

13. The method of claim 10, wherein the another processing step of applying the at least one powdered component is performed after the one processing step of applying the at least one liquid component.

14. The method according to claim 1, wherein at least one first material mixture is applied in at least one first partial section (7, 8, 9) of the veneer (1) to be produced, and at least one other material mixture is applied in other partial sections (7, 8, 9) of the veneer (1) to be produced.

15. The method according to claim 14, wherein the at least one other material mixture is differently dyed than the at least one first material mixture.

16. The method according to claim 6, wherein the binder comprises an adhesive component.

17. The method according to claim 16, wherein the adhesive component is protein based.

18. The method according to claim 1, wherein the several layers (4) of the at least one material mixture are applied automatically on the support frame (2), on the spatially curved, exterior surface (3) thereof by using a computer-controlled application based on a digital model of the denture.

19. A layering device (10) for forming a veneer for a denture, comprising at least one support frame receiver (11, 11′) that is fastenable to or is formed on a support frame (2) on which the veneer (1) is produced, at least one positioning device (12) adapted to spatially position the support frame receiver (11), at least one application device (13, 14) adapted to apply a material mixture, and at least one computer-supported control device (15), at least one of the positioning device (12) or the application device(s) (13, 14) are controllable by the control device.

20. The layering device (10) according to claim 19, wherein the at least one of the positioning devices (12) or the application device(s) (13, 14) are controllable by the control device in a spatially movable fashion.

21. The layering device (10) according to claim 19, further comprising a vibration device (16) adapted to vibrate the support frame receiver (11).

22. The layering device (10) according to claim 19, further comprising a magazine (17) adapted to provide different material components or mixtures.

23. The layering device (10) according to claim 19, further comprising at least one drying device (18) adapted to drying the material mixture.

24. The layering device (10) according to claim 19, further comprising at least one mechanical shaping device (19) adapted to post-process a shape of layers (4) of the material mixture applied to the support frame (2).
